(19) United States
(12) Patent Application Publication
(10) Pub. No.: US 2007/0299985 A1
(43) Pub. Date: Dec. 27, 2007

(54) Systems and methods for template based website construction

(76) Inventors: Jeremy S. Craig, Anaheim, CA (US); William N. Olson, Foothill Ranch, CA (US); Amir Segal, Fullerton, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/475,390

(22) Filed: Jun. 27, 2006

(51) Int. Cl. G06F 15/16

(52) U.S. Cl. 709/245; 709/203

(57) ABSTRACT

Aspects of the present disclosure include systems and methods for a user friendly, low cost, automatic website design. In one embodiment, a user wishing to design a website uses an automatic website design interface in order to automatically create a website. The website design interface obtains user preferences and automatically generates a customized website. The website design interface allows a user to dynamically link web pages, create customized web pages using segment blocks, specify a preferred type of framing for linking outside of the customized website, as well as configure the website in order to increase the likelihood of being found by a search engine. Another aspect of the present invention includes an automatic notification and agent routing system for prompt response to a potential customer's inquiries. Other aspects of the present disclosure include a customizable customer website.

### FIELD OF THE INVENTION

The invention relates to the field of automated website construction.

### BACKGROUND

The Internet is an important tool for marketing and sharing information. Marketing or sharing information on the internet is often done using a website. Many individuals and businesses, however, lack the skills to build their own websites and hiring a website developer can be expensive. This is particularly true in the real estate industry. Individuals and small groups of real estate agents desire a website but are unable to obtain one due to cost or lack of design skills.

Even where a user develops a website, it often goes unnoticed by potential website viewers because the viewers do not see the website. In order to find information on the Internet, a user either has to know the Uniform Resource Locator (URL) address of the desired information or use a search engine to find the information. Search engines generally produce a list of websites related to a key word for phrase entered by a user. Search engines use various methods and algorithms for finding websites related to the user's key word or phrase. In general, search engines rank search results in an attempt to identify and display the most appropriate websites for a given key word or phrase. Because most users review the search results in order from highest ranked to lowest ranked, it is important for a website to be ranked at or near the top of the listed websites for a given search.

### SUMMARY

Aspects of the present disclosure include systems and methods for a user friendly, low cost, automatic website design. In one embodiment, a user wishing to design a website uses an automatic website design interface in order to automatically create a website. The website design interface obtains user preferences and automatically generates a customized website. The website design interface allows a user to dynamically link web pages, create customized web pages using segment blocks, specify a preferred type of framing for linking within or outside of the website, as well as configure the website in order to increase the likelihood of being highly ranked by a search engine. Another aspect of the present disclosure includes an automatic customer notification system when a new home listing is posted. Other aspects of the present disclosure include an automatically updated customer interactive website. A user can be a client wishing to develop a website or a third party who assists the client in developing a website.

In one embodiment a method for generating a website is disclosed. The method includes the steps of providing a user customizable homepage, providing a first plurality of user customizable webpages, providing a website organization user interface, organizing the first plurality of user customizable webpages based on a user's input into sections having a second plurality of webpages selected from the first plurality of webpages, linking each webpage in the second plurality of webpages to every other webpage in the second plurality of webpages, linking at least one page in the second plurality of webpages from the homepage, obtaining a target phrase, automatically determining at least one website configuration field based on the target phrase, and automatically configuring the user customizable homepage and the first plurality of webpages using the configuration field.

In one embodiment, a system for automatic search engine configuration of a website is disclosed. The system includes a target phrase determination module configured to determine a target phrase, a website element determination module configured to determine at least one website element based on the target phrase, and a website configuration module configured to configure a website based on the at least one website element. In one embodiment the target phrase determination module is further configured to determine a target phrase based on user provided information. In one embodiment the system includes a user interface module configured to allow a user to alter the target phrase. In one embodiment, the system includes a user interface module configured to allow a user to enter a target phrase. In one embodiment, the system includes a user interface module configured to allow a user to alter the at least one website element. In one embodiment, the system includes a user interface module configured to allow a user to enter the at least one website element.

In one embodiment the at least one website element is an H1 tag. In one embodiment the at least one website element is an Alt tag. In one embodiment the at least one website element is a descriptive title. In one embodiment the at least one website element is a file name. In one embodiment the at least one website element is a link. In one embodiment the at least one website element is sub-domain.

In one embodiment, an automated method for search engine configuration of a website is disclosed. The method includes the steps of obtaining a target phrase, automatically determining at least one website configuration field based on the target phrase, and automatically configuring a website using the configuration field. In one embodiment, the step of obtaining a target phrase includes obtaining a target phrase from a user. In one embodiment, the step of obtaining a target phrase includes generating a target phrase based on the website's content. In one embodiment, the step of obtaining a target phrase includes generating a target phrase based on user provided information.

In one embodiment, a method for link aliasing is disclosed. The method includes the steps of providing a desired link from a first website to a second website, generating a relatively short description for the link and a relatively longer description for the link, and automatically incorporating at least two links to the first website, wherein one of the at least two links includes the short description and one of the at least two links includes the long description. In one embodiment, the method includes the step of automatically incorporating at least one of the two links into a navigation section. In one embodiment, the method includes the step of automatically locating the short descriptive link on a top portion of the website. In one embodiment, the method includes the step of automatically locating the short descriptive link on a side portion of the website. In one embodiment, the method includes the step of automatically locating the long descriptive link on a bottom portion of the website. In one embodiment, at least one of the links is a flash based link. In one embodiment, at least one of the links is an HTML based link.

In one embodiment, an organizational structure for a website is disclosed. The organizational structure includes a homepage having a first navigation section, a subsection of webpages including a plurality of webpages, wherein each webpage in the subsection of webpages has the first navigation section and a second navigation section, wherein the first navigation section includes a link to at least one of the pages of the subsection of webpages, wherein the second navigation section includes a plurality of links corresponding to the plurality of pages of the subsection of webpages, and wherein the website is automatically generated using a user modified template.

In one embodiment, a method of organizing webpages for automatically generating a website is disclosed. The method includes the steps of providing a user customizable homepage, providing a first plurality of user customizable webpages, providing a website organization user interface, organizing the first plurality of user customizable webpages based on a user's input into sections having a second plurality of webpages selected from the first plurality of webpages, linking each webpage in the second plurality of webpages to every other webpage in the second plurality of webpages, and linking at least one page in the second plurality of webpages from the homepage.

In one embodiment, a template based webpage is disclosed. The template based webpage includes a first navigation section having at least one link, a dynamic content section having at least one content block selectable by a user, and a footer section having at least one link. In one embodiment, the webpage includes at least a second content block selectable by the user. In one embodiment, the content blocks are configured to be spatially arranged by the user. In one embodiment, the at least one content block includes a user customizable pre-designed webpage content section. In one embodiment, the webpage includes a second navigation section including at least one link.

In one embodiment, a system for customizing a template based webpage is disclosed. The system includes a template based webpage having at least one user customizable content area, a content block user interface having at least one content block wherein the content block user interface is configured to allow a user to customize a content block, and wherein the content block user interface is further configured to incorporate the user customizable content block into the user customizable content area. In one embodiment, the content block user interface has at least two content blocks. In one embodiment, the content block user interface has a multiplicity of content blocks.

In one embodiment, a method for customizing a template based webpage is disclosed. The method includes the steps of providing a template based webpage having at least one user customizable content area, providing a content block user interface having at least one content block wherein the content block user interface is configured to allow a user to customize a content block, and automatically incorporating the user configured content block into the user customizable content area.

In one embodiment, an automated system for generating a link in a template based webpage is disclosed. The system includes at least one template based webpage, a user interface configured to obtain user information and generate and incorporate a link on the at least one template based webpage using the user information, and wherein the user information includes content location information and a link build type. In one embodiment, the link build type is a dynamic frame, a dynamic I-frame, or a pop-up window. In one embodiment, the content is a document or a network page. In one embodiment, the document is a text file or spreadsheet file. In one embodiment, the network page is a third party webpage or a user designed network page. In one embodiment, the network page is a separate page within the website being designed by the user. In one embodiment, the content location information is a URL address. In one embodiment, the content location information is a folder location.

In one embodiment, a method for generating a link in a template based webpage is disclosed. The method includes the steps of providing at least one template based webpage, obtaining user information, automatically generating a link based on the user information, automatically incorporating the link on the at least one template based webpage, and wherein the user information includes content location information and a link build type.

In one embodiment, a real estate customer notification system is disclosed. The real estate customer notification system includes a search engine module configured to search a database of real estate listings using user specified criteria and a user configurable summary interface configured to display and track the real estate listings found by the search engine module. In one embodiment, a user is able to configure the user configurable summary interface to include preference information. In one embodiment, a user is able to configure the user configurable summary interface to include search criteria information.

In one embodiment, a real estate customer notification method is disclosed. The method includes the steps of obtaining user specified criteria, searching a database of real estate listings using the user specified criteria, and updating a user configurable summary interface configured to display and track the real estate listings found by the search engine module.

In one embodiment, a new real estate listing notification system is disclosed. The system includes a new listing tracking module configured to track and identify new real estate listings of interest and a notification module configured to promptly notify a client of the new real estate listing of interest. In one embodiment, promptly notifying the client includes sending a message to a cell phone.

### BRIEF DESCRIPTION OF THE DRAWINGS

The drawings and the associated descriptions are provided to illustrate embodiments of the disclosure and not to limit the scope of the claims.

FIG. 1 illustrates one embodiment of an automatic website design system.

FIG. 2 illustrates one embodiment of a database associated with the automatic website design system of FIG. 1.

FIG. 3 illustrates one embodiment of a user interface for storing content and accessing stored content.

FIG. 4 illustrates one embodiment of a user interface for reviewing or editing a page or section layout of a website.

FIG. 5 illustrates one embodiment of a user interface for adding a page or a section to a website.

FIG. 6 illustrates one embodiment of a user interface for reviewing or editing a page or section layout of a section of a website.

FIG. 7 illustrates a diagram of a website layout.

FIG. 8 illustrates one embodiment of a website flowchart.

FIG. 9 illustrates one embodiment of a webpage layout.

FIG. 10 illustrates one embodiment of a user interface for organizing content blocks on a webpage.

FIGS. 11A-11B illustrate embodiments of a user interface for editing a content block.

FIGS. 12A-12B illustrate embodiments of a webpage built using content blocks.

FIG. 13 illustrates one embodiment of a user interface for creating links.

FIG. 14A illustrates one embodiment of a dynamic frame link.

FIG. 14B illustrates one embodiment of a dynamic i-frame link.

FIG. 14C illustrates one embodiment of a pop-up link.

FIG. 15 illustrates a flow chart of a search engine configuration process.

FIG. 16 illustrates one embodiment of a user interface for configuring a website for search engine purposes.

FIG. 17 illustrates one embodiment of a flowchart of a search engine configuration system.

FIG. 18 illustrates one embodiment of a search engine configured website.

FIG. 19 illustrates one embodiment of link aliasing.

FIG. 20A illustrates one embodiment of a customer listing notification system.

FIG. 20B illustrates one embodiment of customer personalized webpage update system.

FIG. 21 illustrates one embodiment of a customer personalized webpage.

### DETAILED DESCRIPTION

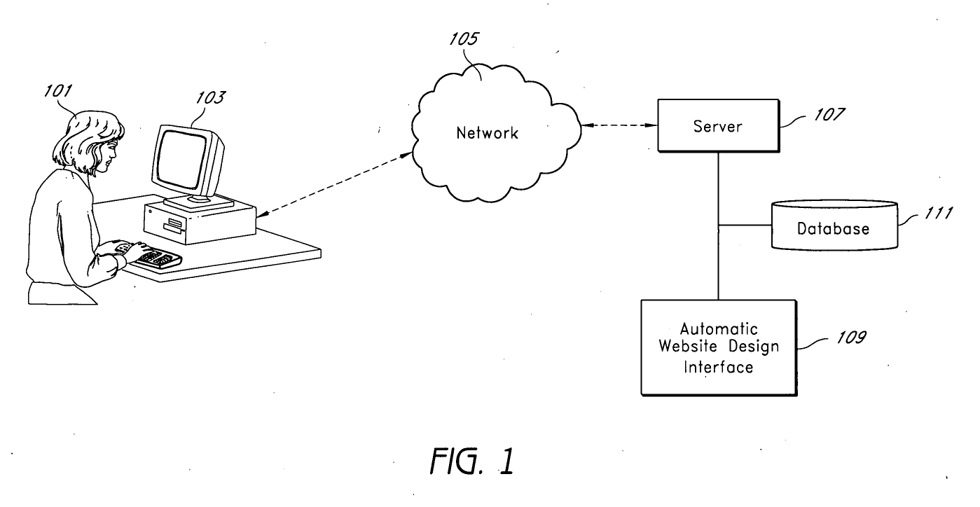

FIG. 1 illustrates a network-based system for automatic website design. A user 101 logs onto a network 105, such as the Internet, through a computer 103. The user 101 then interfaces with an automatic website design interface 109 through a server 107. The automatic website design interface 109 communicates with a database 111. In one embodiment, the automatic website design interface 109 aids a user in developing a website. In one embodiment, the automatic website design interface 109 aids a user in developing a dynamically linked multiple nested page website. In one embodiment, the automatic website design interface 109 aids a user in developing a webpage using content blocks. In one embodiment, the automatic website design interface 109 allows a user to link to another webpage or file through the use of dynamically framed web pages, dynamically i-framed web pages, and pop-up web pages. In one embodiment, a user configures a website for search engine purposes using the automatic website design interface 109. The word automatic as applied herein means that at least one step is performed by software. The user can be a client who wants to design their own website, or a third party who aids the client in designing a website. In one embodiment, the third party is the operator of the automatic website design interface 109.

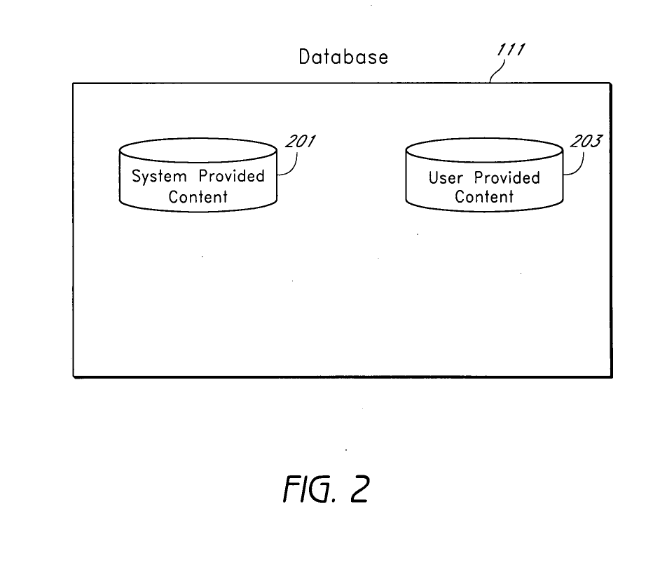

FIG. 2 illustrates one embodiment of the database 111. The database 111 includes a database 201 of system provided content and a database 203 of user provided content. A user developing a website using the automatic website design interface 109 can access both the system provided content database 201 and the user provided content database 203. The user can upload personal content onto the user provided content database 203. In one embodiment, the user provided content database 203 is only accessible by the user who uploaded the content. In one embodiment, the user provided content database 203 is accessible by the user and other users. In one embodiment, the system provided content 201 is accessible by all users. In one embodiment, content in the system provided content 201 is available based on the subscription level of the user.

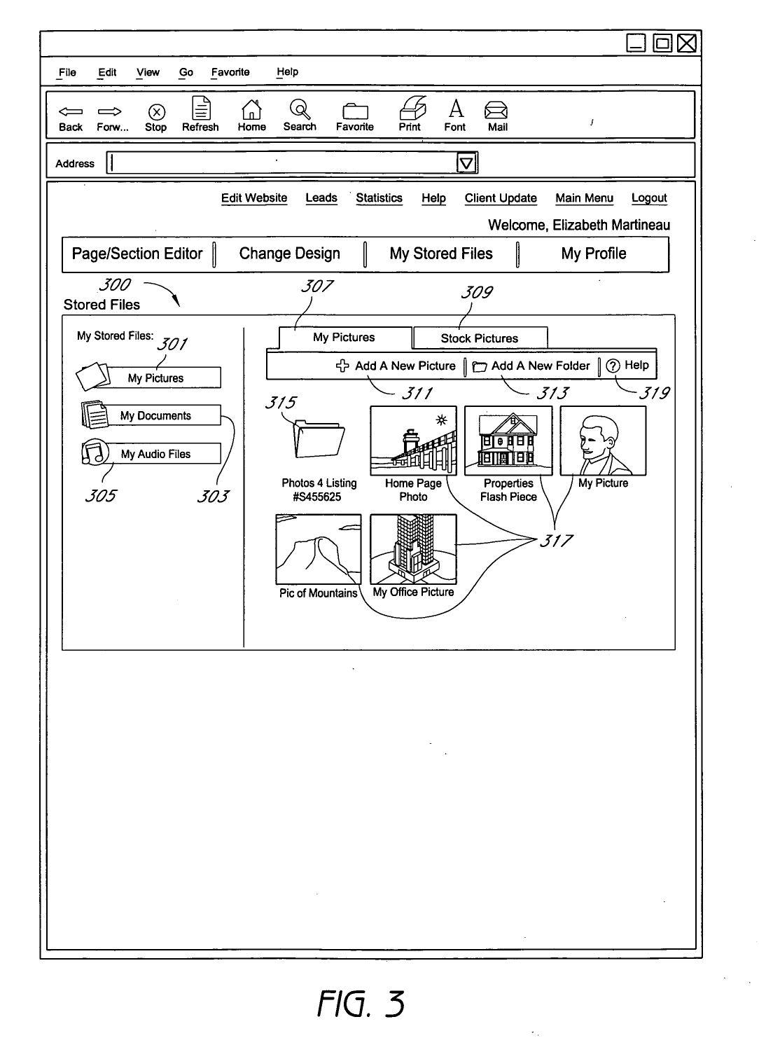

FIG. 3 illustrates one embodiment of a user interface 300 for storing website content and accessing stored website content. The user interface 300 has a my pictures 301 storage area, a my documents 303 storage area, and a my audio files 305 storage area. The my pictures 301 storage area allows a user to upload and access graphic files. The my documents 303 storage area allows a user to upload and access text files. The my audio files 305 storage area allows a user to upload and access audio files. Each storage area also has sub-areas and folders which are accessible through the user interface. For example, as illustrated in FIG. 3, the my pictures 301 storage area has two separate sub-areas for user stored content, identified as the my pictures sub-area 307 and system provided content, identified as the stock pictures sub-area 309. The pictures provided in the stock pictures sub-area 309 are provided to the user. The pictures in the my pictures sub-area 307 are provided by the user and are uploaded and stored in the my pictures sub-area 307 by the user. The user can organize pictures by adding folders and sub-folders by, for example, using the add a new folder function 313 or add pictures using the add a new picture function 311 or right clicking on the mouse and using a drop down menu to add a folder or picture. Of course a user can also delete a picture or a folder as well as rearrange folders and pictures. The layout and functions described with respect to pictures is also equally applicable to documents and audio files. The user is able to quickly and easily design and redesign a website in an easy and convenient fashion using the stored and provided content in the database 111.

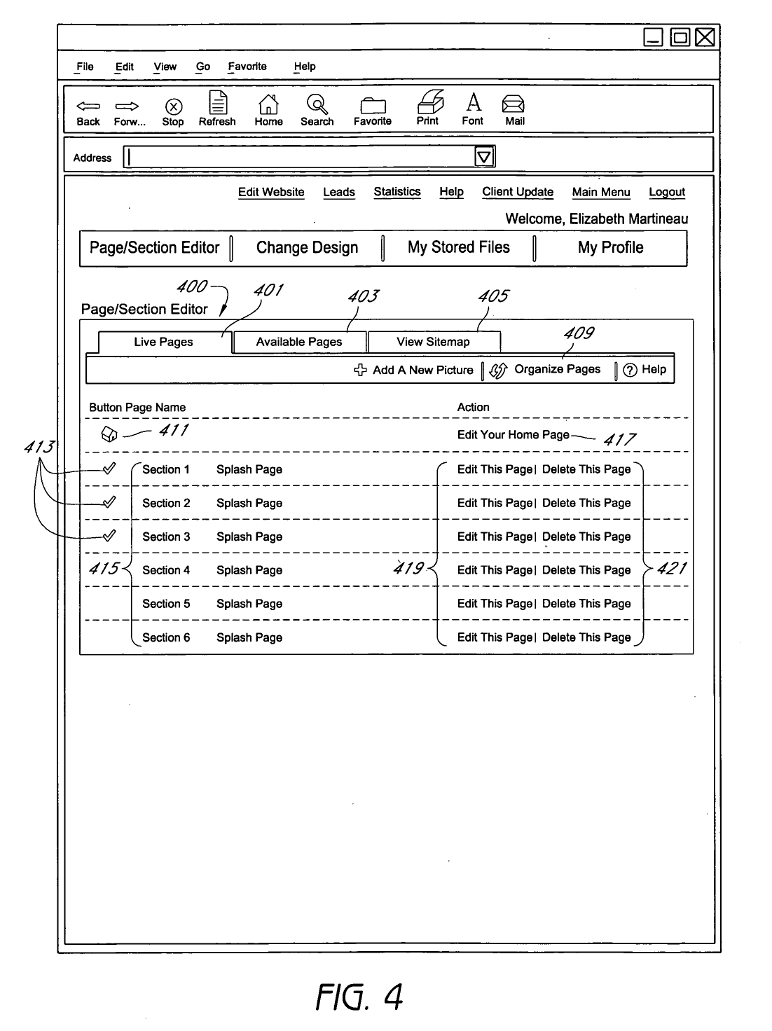

FIG. 4 illustrates one embodiment of a website map management interface 400. The website map management interface 400 allows a user to organize, edit, delete, and keep track of the web pages and sections created. The live pages tab 401 allows a user to view the web pages and sections that are currently posted on the user's website. The available pages tab 403 allows a user to view a list of predesigned web pages that can be added to the live web pages section 401. The web pages listed in the tab 403 are provided to the user or are designed by the user and stored for latter use. The view sitemap tab 405 allows a user to view the full map of the designed website in a complete layout form.

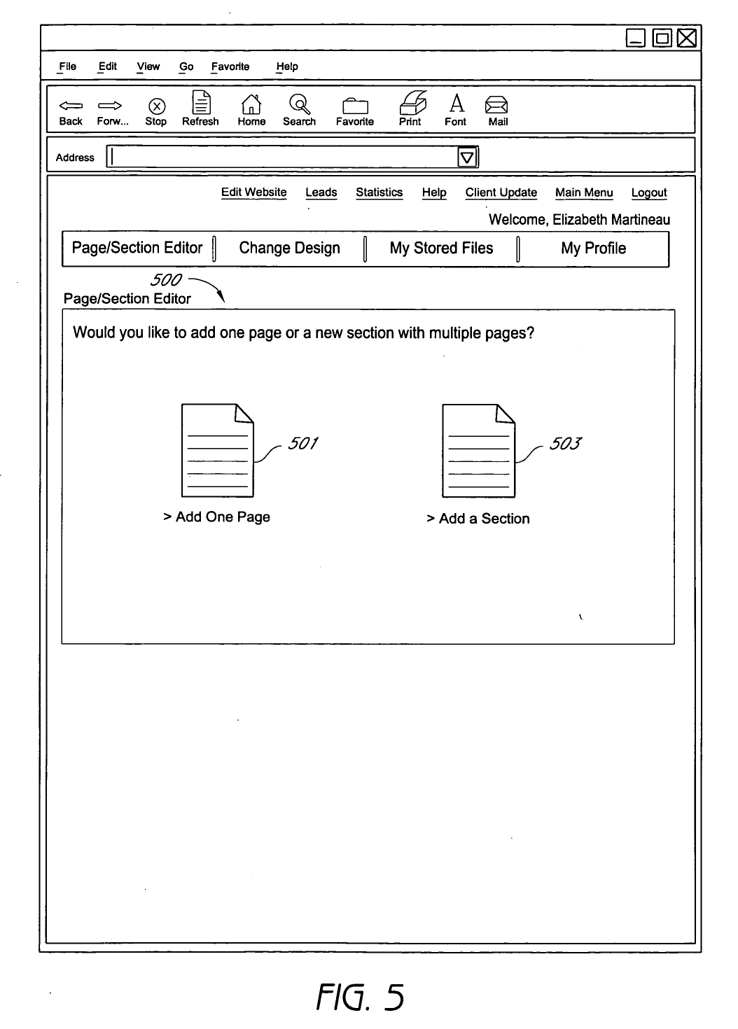

The live pages section 401 allows a user to manage the current web pages on the user's website. By clicking on the add page or section function 407, the user is assisted in choosing or creating a web page to add to the website as will be described in relation to FIG. 5. The organize pages function 409 allows a user to organize and reorganize the web pages and sections. As illustrated in FIG. 4, the live pages section 401 is organized into sections or pages. The first section or page is the home page 411. Link 417 allows a user to edit the home page 411. Sections or pages 415 are listed below the homepage 411. For each section or page 415, the user is allowed to choose whether to have a hyperlink button on the navigation pane of the home page as will be described below. If a user decides to have a hyperlink button on the navigation pane of the home page, the user can create a check 413 next to the section or page to be linked from the navigation pane of the home page in order to indicate that a particular section or page is to have a hyperlink button on the navigation pane of the home page. The hyperlink button can be, for example, a flash or html hyperlink button. A user can also edit or delete a section or page 415 using edit this page function 417 and delete this page function 421, or by right clicking on the mouse and selecting the appropriate function. The simple interface provides for an easily understood and easy to use system for developing a personalized website using a template based website design system.

FIG. 5 illustrates one embodiment of a user interface for adding a page or a section to a website. The interface 500 allows a user to choose whether to add a single page 501 or whether to add a section 503. Adding a single page allows a user to add a page to a previously created section or to add a page to link from the homepage. Adding a section allows a user to create a section of multiple cross-linked web pages automatically as will be described in more detail below.

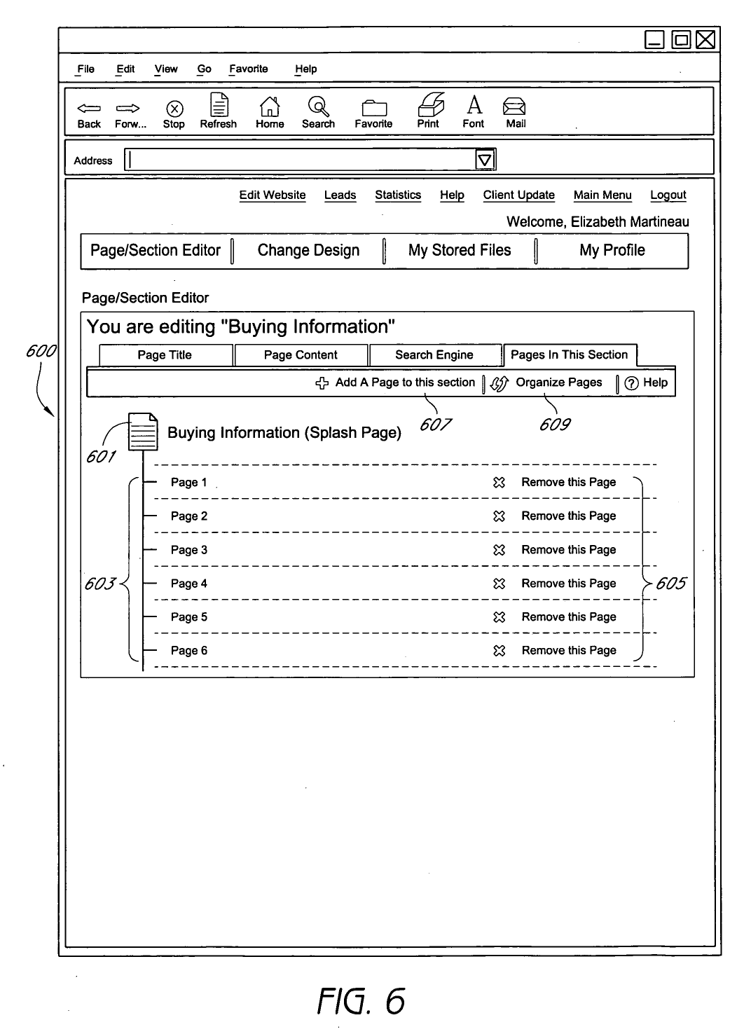

FIG. 6 illustrates one embodiment of a page section editor for editing and organizing sections. Page section editor 600 has section heading 601 and pages 603. The user is allowed to add a page to a particular section by using the add a page section function link 607, as well as organize pages using the organization page function link 609. The user is also allowed to remove or edit a particular page using remove page functions 605. In one embodiment, a user is able to link a secondary section from the main section. For example, in addition pages 603, secondary sections can be linked from within the primary section 601. A user can link a single page or section from section 601 or a user can link a plurality of pages or sections from section 601.

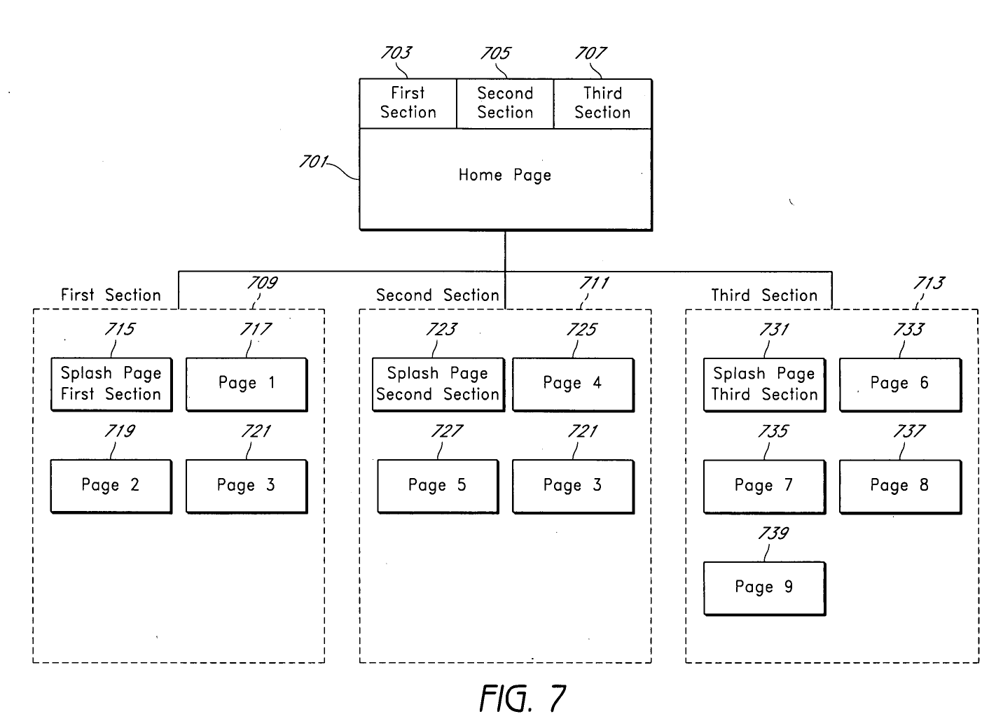

FIG. 7 illustrates a graphical representation of an automatically generated nested website design map. The automatically created nested website has home page 701 and first section 709, second section 711, and third section 713. The home page 701 has first section link 703, second section link 705, and third section link 707. First section link 703 links to the first section 709, the second section 705 links to the second section 711, and the third section link 707 links to the third section 713. A website viewer viewing the home page 701 is able to look at the home page and decide whether they want to continue on to one of the sections. When the user clicks on the first section 703, they will be transferred to a first section splash page 715.

The first section splash page introduces the purpose of the section and has a number of pages dynamically linked from that splash page. For example, the first section 709 has a splash page 715 and page one 717, page two 719, and page three 721. Each of the pages in the first section 709 are dynamically linked to every other page in that section. For example, page one 717 has links to a splash page 715, page two 719, and page three 721. Page three has links to the splash page 715, page one 717, and page two 719. In addition, the pages in the first section 709 have links back to the home page 701 and can also include links to pages or other sections. For example, page one can also have a link to the second section. The second section 711 will also have pages, such as splash page 723, page four 725, page five 727, and page three 721. Note that page three 721 is in both the first section and the second section. If a user wishes to have the same page linked to two different sections, a user is able to do so and, in generating the website, a copy of the page is created so that two identical pages are generated and stored in each section. In addition, when a user edits one of the page three 721 web pages, the other page three 721 web page is automatically edited as well.

The third section illustrates an example of five different pages within a particular section. Sections may have one or more pages, and can have any number of pages that the user wishes to have. In addition, sections can also have sub-sections which are dynamically linked from the main section, such that, for example, page nine 739 may be the splash page link for a fourth section (not shown) that can have multiple pages within that section. In this way, a user is able to dynamically create multiple nested web pages easily, quickly, and efficiently. The dynamically linked pages and sections allow a user to quickly and efficiently navigate the website without having to use the back button. Thus, a user can navigate quickly any page in the website from any other page in the website without having to click on the back button.

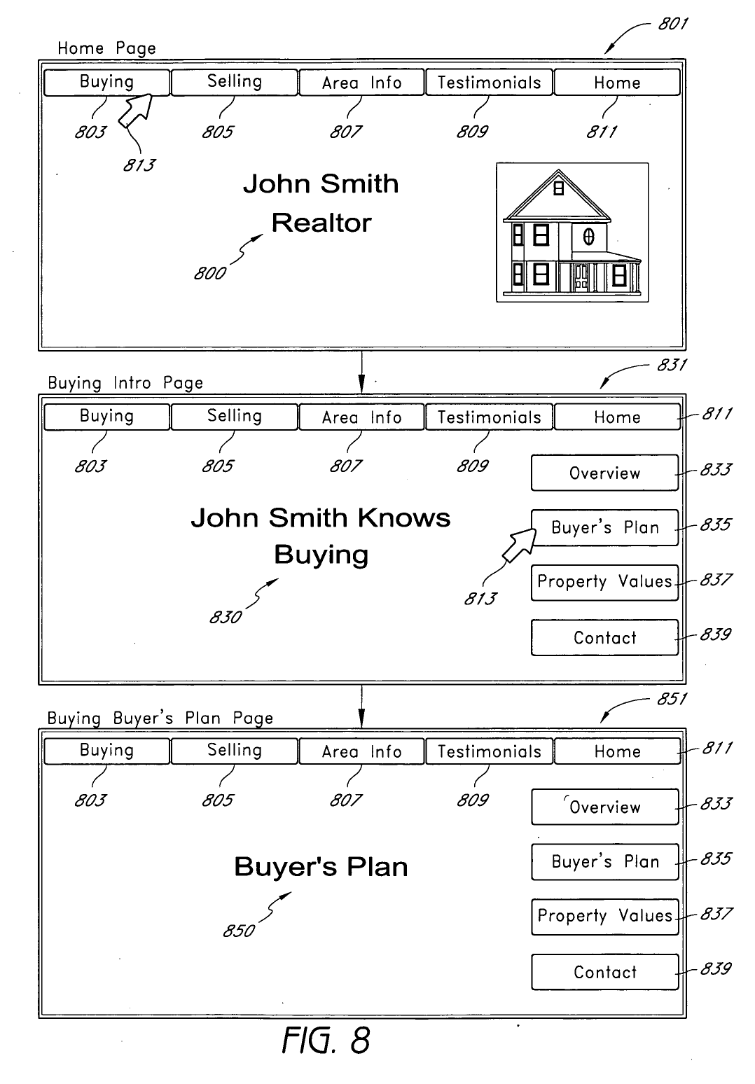

FIG. 8 illustrates the flow of one embodiment of a website, A website viewer logs on to a home page 801. The home page may have content 800 and links to other pages. In one embodiment, the home page 801 has a navigation pane or set of links. Homepage links may include, such as, for example, buying link 803, selling link 805, area info link 807, testimonials link 809, and home page link 811. A user can select a link using mouse arrow 813. Once a link is chosen, the user is automatically transferred to that page. For example, if a user selects the buying link 803, the user is transferred to the buying introduction or splash page 831. Note that the buying introduction or splash page 831 also has the same navigation pane or links across the top of the page as the home page 801 has. This allows a user to quickly navigate between the different sections without having to use the back page function included in most website browsers. The navigation pane or links at the top of the pages may differ from the home page navigation pane or links; however, it is useful to have the same links as the home page for easy navigation and website consistency. Note that in addition to the change content 830 and the buying intro or splash page 831, there are also sub-page navigation links, such as overview 833, buyer's plan link 835, property values link 837, and contact link 839. A user wishing to navigate within the section can use one of the links by clicking on it with their mouse 813. For example, if a user clicked on the buyer's plan link 835, a user would be transferred to the buyer's plan page 851. Note that the buyer's plan page 851 has different content 850; however, it has the same top and side navigation panes and links as the buying introduction page 831.

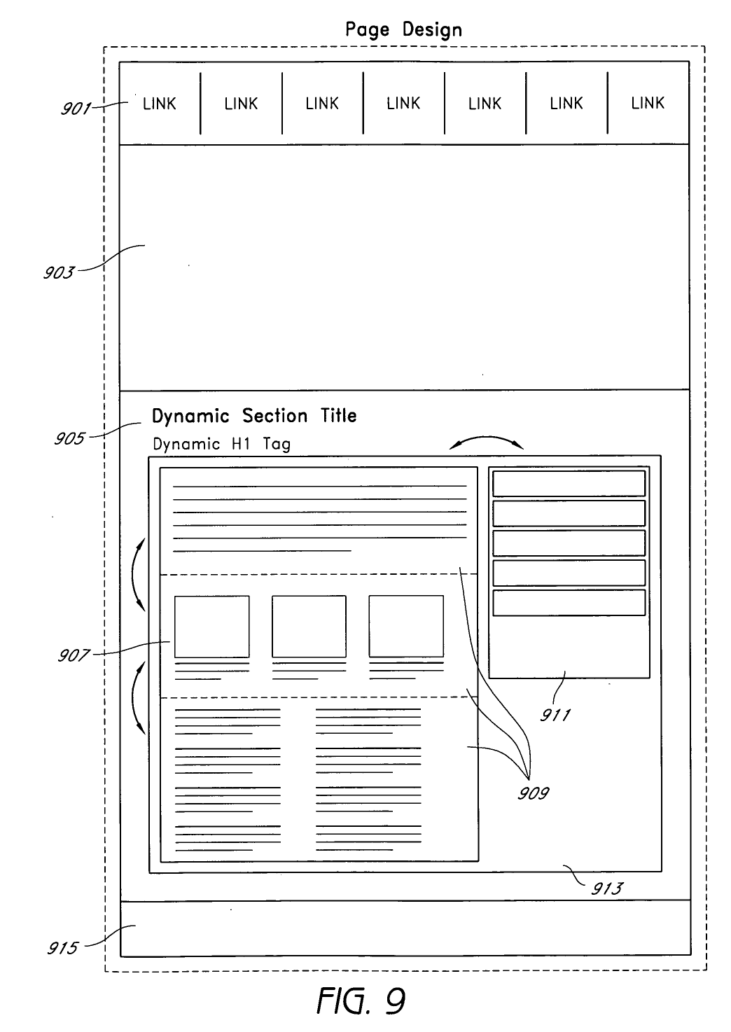

FIG. 9 illustrates one embodiment of a tablet page design layout generated by the automatic website design interface. The page design begins with dynamic HTML or flash navigation links 901, having various links. Vertically below the dynamic HTML or flash navigation links 901 is a dynamic JPG, GIF, or flash image section 903 where a user is able to upload or use a graphic of some kind to capture a viewer's attention. Below the dynamic JPG, GIF, or flash image section 903 is a dynamic section title 905 having a dynamic H1 tag. The dynamic section title changes depending on the page that a viewer is viewing and the dynamic H1 tag changes based on the dynamic section title. Below the dynamic section title 905 is a dynamic content table section 907. The dynamic content table section 907 has segments 909 which will be described in more detail below. In addition, the dynamic content table 907 also has an optional dynamic sub-navigation table 911 which is used when the page is connected to a section. The dynamic content table 907 and optional dynamic sub-navigation table 911 are included within section 913 for easy design. In addition, the web page also has a dynamic footer 915. The dynamic footer 915 is generated with a number of links and/or other information relevant to the content of the webpage and website. In one embodiment, the dynamic footer 915 contains aliased links as will be described in more detail below.

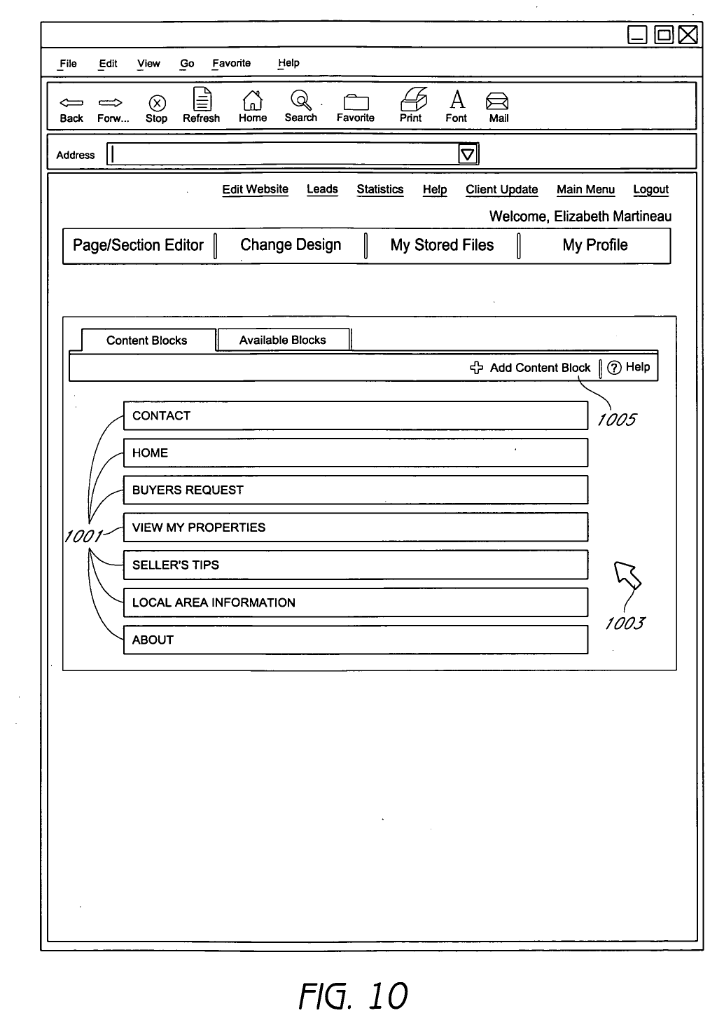

FIG. 10 illustrates a user interface for organizing segments or content blocks, also referred to as sections in this application, in which a user is able to organize the content blocks for use within the dynamic content table 907. The user interface 1000 has segments 1001, such as contact segment, home segment, buyer's request segment, view my property segment, seller's tips segment, local area info segments, as well as other segments. Each segment contains a pre-designed set of information which is customizable by the user, as will be described in more detail below. A user is able to use a mouse, such as mouse 1003, to rearrange the content block order so that a user can customize their website according to which content they wish a viewer to view first. In addition, the user can add a content block by clicking on the add a content block function 1005, or remove a content block by deleting it.

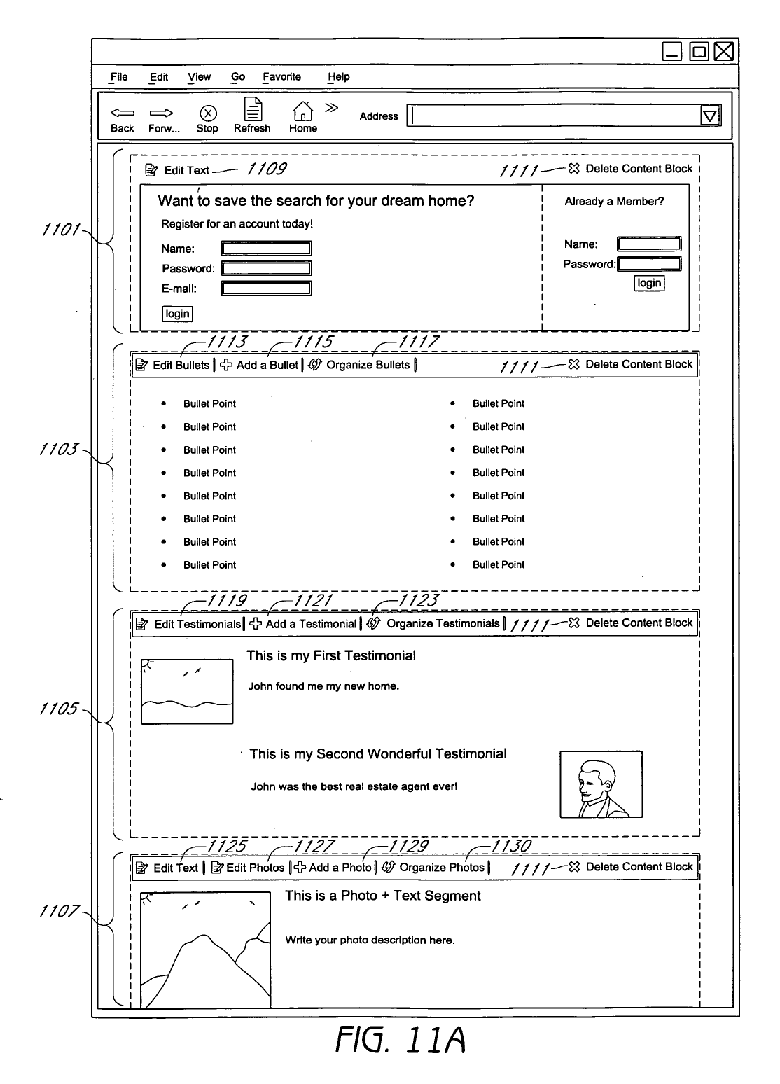

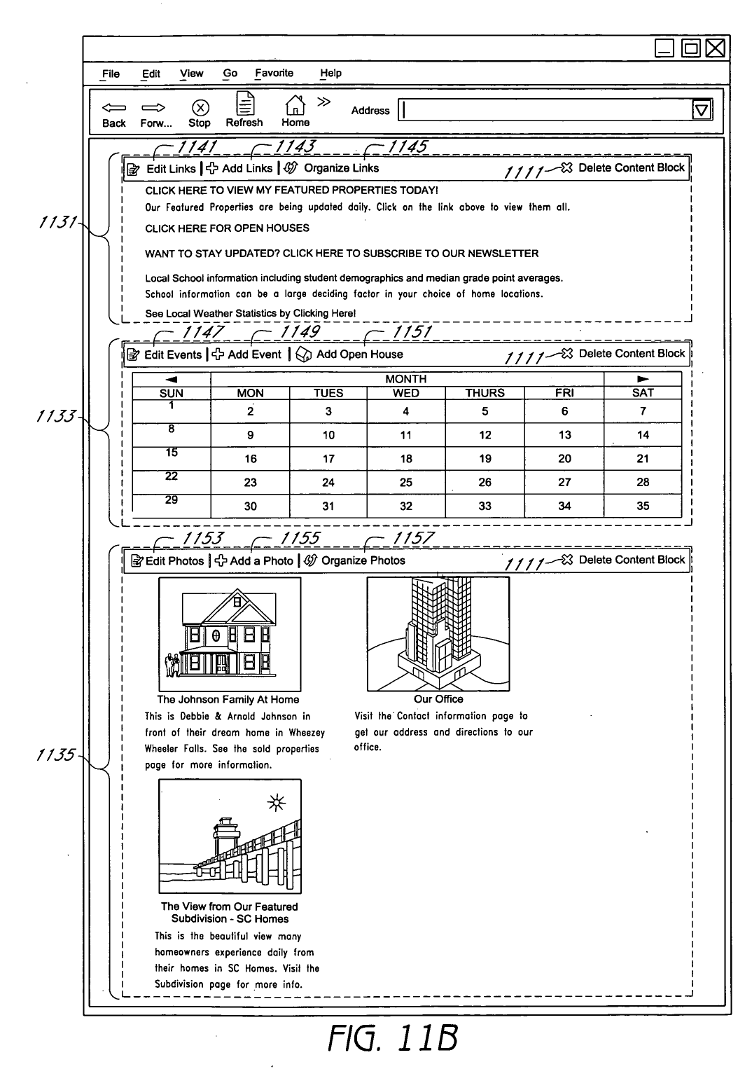

FIGS. 11A-11B illustrate embodiments of content block editing pages. The content block or segment editing pages have various segments, such as segment one 1001, segment two 1003, segment three 1005, and segment four 1007. Segment one 1001 is a segment which allows a viewer to search for a particular property. Segment two 1003 is provided to allow a user to create a list of bullet points to describe whatever a user wishes to describe on their own web page. Segment three 1005 allows a user to create testimonials to describe how they have helped other people buy property in the past. Segment four 1007 allows a user to upload a photo and add text to that photo to describe, for example, a particular property or to describe and illustrate other valuable information on their website. FIG. 11B illustrates additional segments including local information segment 1131, calendar segment 1133, and photo segments 1135. Various segments can be created covering any number of topics, for example, in one embodiment, the segments include segments such as property group segments, featured property slide show segments, IDX quick search segments, IDX detailed search segments, IDX property update sign-up form segments, form segments, text segments, photo segments, text and photo segments, testimonial segments, calendar segments, separator segments, audiophile segments, headline segments, and link partner segments.

FIGS. 11A and 11B have functions that allow a user to customize a particular content block, in addition to adding, deleting, and organizing the various content blocks. Segment one 1101, which allows a user to search for a particular property, has edit text button 1109 and delete content block button 1111. The edit text button 1109 allows a user to edit the text contained within the content block, however, a user is not able to change the underlying functionality of the content block. The delete button 1111, allows a user to delete the entire content block. Note that the customize buttons for each content block are different depending on the customizable content contained with each block. For example, segment two 1103 allows a user to generate a list of bullet points. The customize buttons for segment two 1103 include an edit bullets button 1113, an add a bullet button 1115, and a organize a bullet button 1117. Segment three 1105 allows a user to post testimonials. The buttons for segment three 1105 are edit testimonials 1119, add a testimonial 1121, and organize testimonials 1123. Segment four 1107 allows a user to post a photo or graphic and add text next to the photo. Segment four 1107 has buttons for edit text 1125, edit photos 1127, add a photo 1129, and organize photos 1130. Referring to FIG. 11B, local information segment 1131 includes customization buttons edit links 1141, add links 1143, and organize links 1145. Calendar segment 1133 includes customization buttons edit events 1147, add events 1149, and add open house 1151. Photo segments 1135 includes customization buttons edit photos 1153, add a photo 1155, and organize photos 1157.

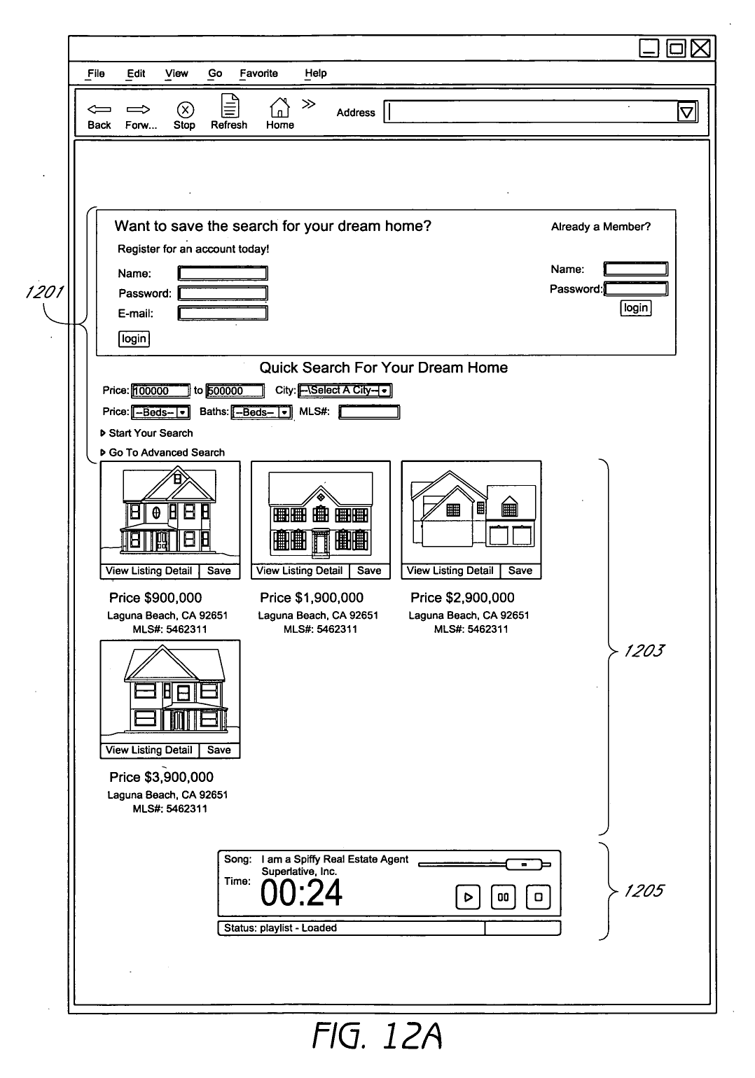

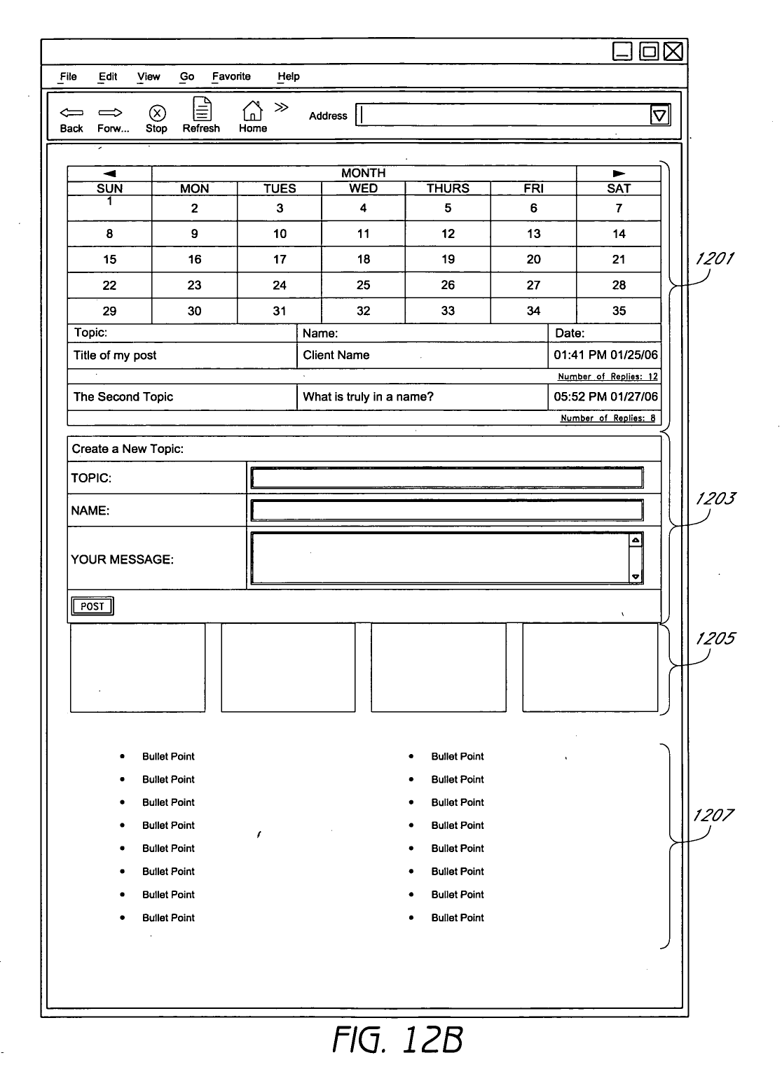

FIGS. 12A and 12B illustrate how the content blocks looks within a created and/or posted website. Note that in FIG. 12 there are no editing functions as there are in FIGS. 11A-11B

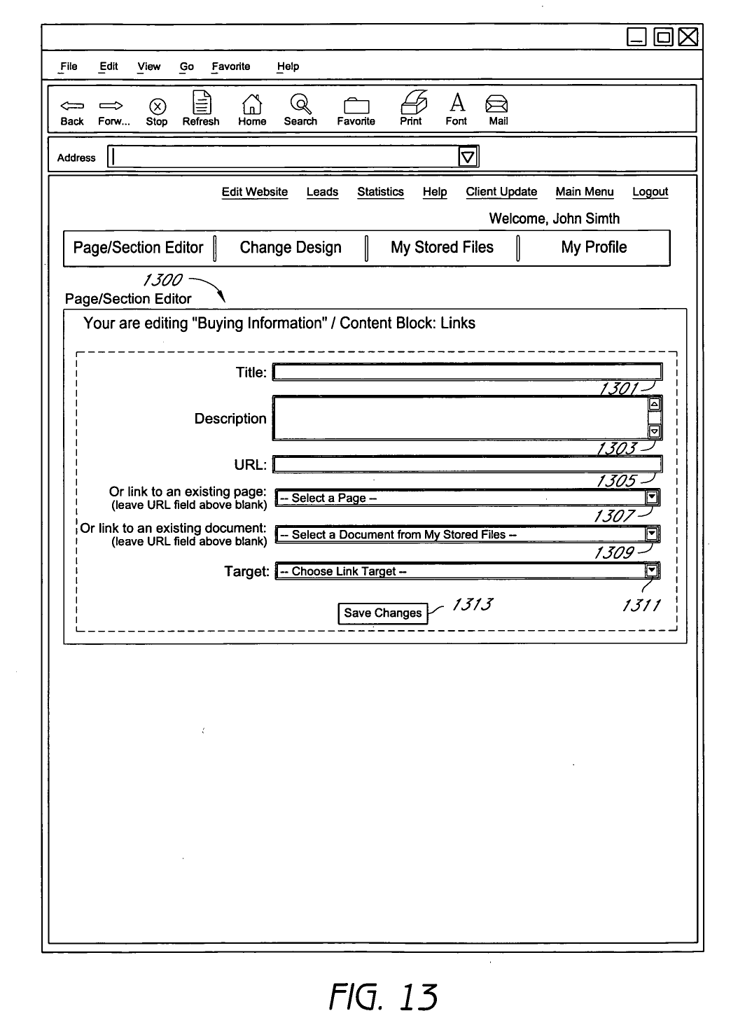

FIG. 13 illustrates one embodiment of a dynamic link decision user interface 1300. The dynamic link user interface 1300 allows a user to choose a particular page or document to dynamically link to from a web page. The dynamic link user interface 1300 has a title field 1301, a description field 1303, a URL field 1305, a link to an existing page field 1307, a link to an existing document field 1307, and a target field 1311. The Title field 1301 is provided to obtain the title of the link. The description field 1303 is provided to obtain a description of the link. The URL field 1305 is provided to obtain the URL address of the link. The link to an existin page field 1307 is provided to allow a user to link to a page that has not been posted, for example a page that is part of the user's website, which does not have a URL. Link to an existing document field 1309 is also provided to allow a user to link to a document that does not have a URL. Thus, fields 1307, 1309 are provided in lieu of the URL field. The target field 1311 allows a user to choose how to frame the content that is the target of the link. The user has the option of choosing whether to dynamically frame the web page or document that is linked from their website, dynamically I-frame the page or document, or allow the document or page to be generated within a pop-up frame.

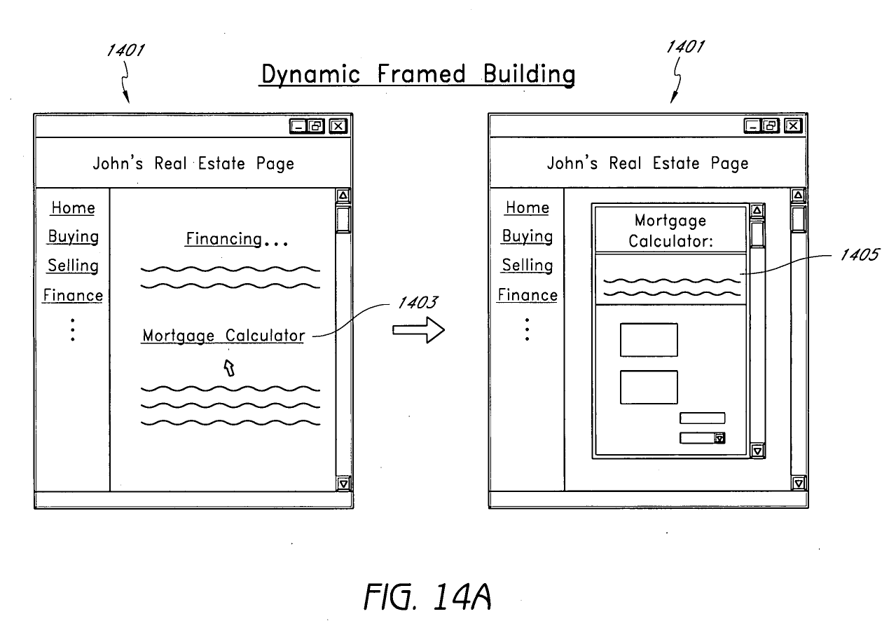

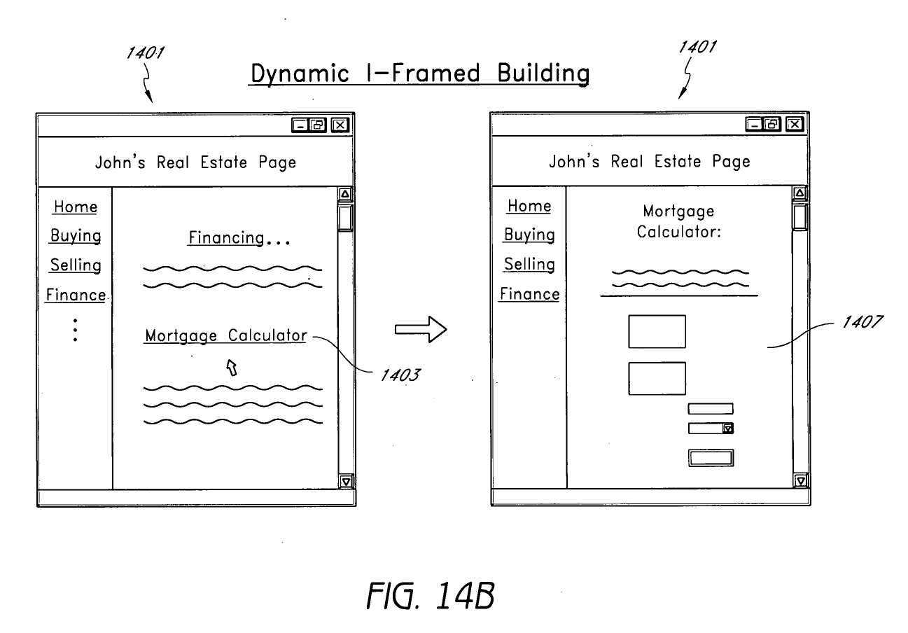

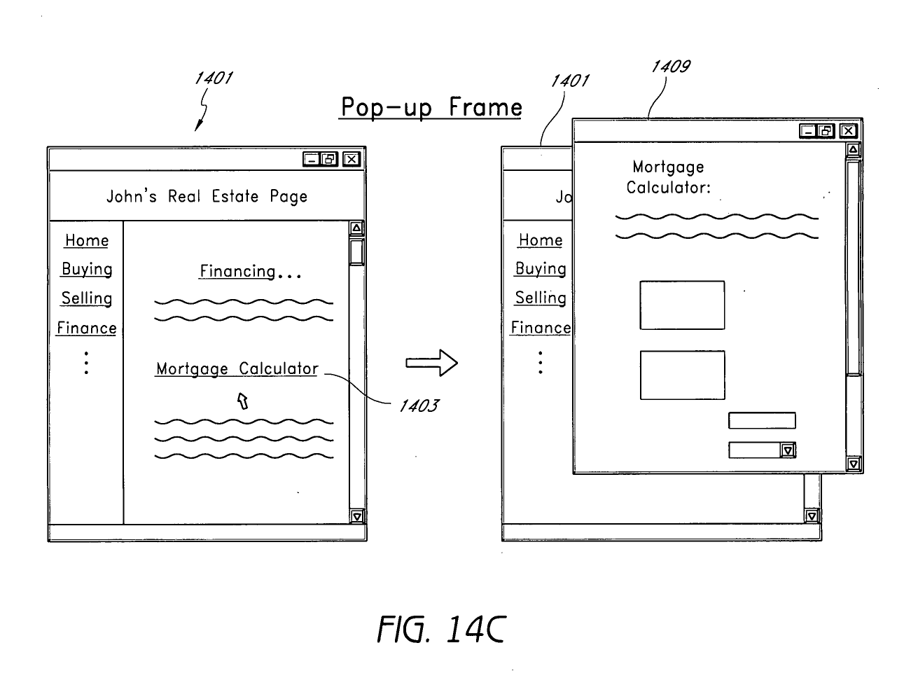

FIG. 14A illustrates an example of a dynamically framed link. As illustrated, when a user views a page 1401 and clicks on a link, such as link 1403 directed at a mortgage calculator page, the mortgage calculator is generated within a frame 1405 that imitates what the mortgage calculator would look like on its own, but it is created within the original web page 1401. This means that a viewer viewing the web page 1401 clicking on the mortgage calculator link will still view main sections of the web page 1401 while they are using the linked page 1405. Note that the linked page 1405 operates independently having its own scroll button from the page 1401.

FIG. 14B illustrates an example of a dynamic I-framed linked page. As with the dynamic framed linked page in FIG. 14A, when a user clicks on the link 1403, the linked page 1407 pops up and is framed within the original page 1401. Note, however, that the dynamically I-framed page 1407 operates in conjunction with the web page 1401 such that they share a scroll button and are moved jointly as a user scrolls through the web page.

FIG. 14C illustrates an example of a pop-up frame page. When a user clicks on the mortgage calculator link 1403, a separate window 1409 is generated where a user is able to access the linked webpage outside of the original website.

In one embodiment, the automatic website design interface allows a user to configure a website for search engine purposes. Search engines use various techniques in categorizing and ranking websites. Search engines often look at the domain name of the website, the file name of the website, the descriptive title, the header tags (H1 tags), the image tags (Alt tags), Meta keywords, and Meta descriptions in order to find a matching website. Search engines also look at the words used on the website in both the content and in the links contained in the website. Search engines also look at what websites a particular website links to and/or is linked from. If the linked websites are popular or well known websites, the links can increase a website's search engine ranking. The automatic website design interface 109 automatically configures a user's website by improving, adding, deleting, or modifying one or more of the above search criteria in order to increase the likelihood of a higher search engine ranking.

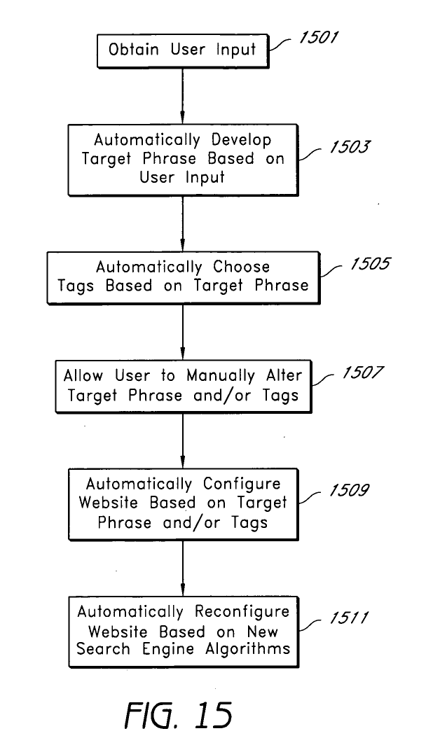

FIG. 15 illustrates one embodiment of a flow chart of a system for improving the search results of a webpage. The interface begins by obtaining user input at block 1501. User input includes such things as business name, location, type of business, areas of interest, among other information related to the user's business and/or website purpose. The user input is then used at block 1503 to automatically develop suggested target phrases based on the user input. For example, if a user wishes to sell real estate in Newport Beach, the suggested target phrase might be “real estate for sale in Newport Beach.” At block 1505, the system automatically chooses tags based on the target phrase. For example, if the target phrase is “real estate for sale in Newport Beach,” the H1 tag may be “John Smith realtor: real estate for sale in Newport Beach.” At block 1507, the user is allowed to manually alter the target phrase and/or the tags from the suggested target phrase and/or tags. At block 1509, the website uses the original or manually altered target phrases and/or tags to automatically configure the website based on the target phrase and/or tags for search engine finding purposes. In one embodiment, the system does not suggest a target phrase, but does suggest tags based on a user provided target phrase. In one embodiment, the system also includes an additional block 1511. At block 1511, the system reconfigures the website's target phrase and tags based on new search engine algorithms.

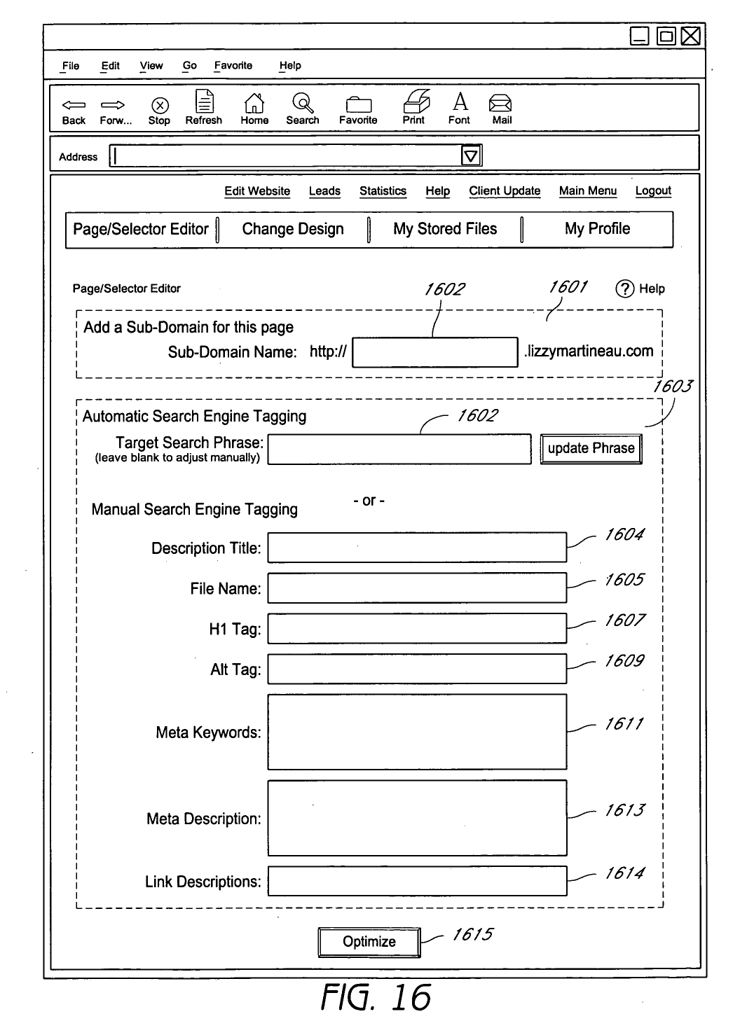

FIG. 16 illustrates a search engine configuration input page. The search engine configuration input page allows a user to enter parameters which are used to automatically configure a website. Field 1601 allows a user to create a sub-domain name for their website. When searching for matching websites and/or ranking a particular website, search engines often look at the domain name to determine relevancy. However, due to the nature of the Internet, domain names must be unique. It is often difficult and/or expensive to obtain the most appropriate and effective domain name. The sub-domain field 1601 allows a user to create an appropriate and effective sub-domain name to the main domain name in order to increase the likelihood of being identified and ranked highly on a search. After a user has entered an appropriate sub-domain name, the user can click on the configure button 1615 in order to automatically create the desired sub-domain with the corresponding name.

Field 1603 allows a user to enter a target phrase in order to configure a website. For example, a user may wish to configure a webpage based on what the user believes a potential website viewer will search for. For example, a potential customer of real estate in Newport Beach, CA, might create the following search phrase: “Real Estate in Newport Beach California.” The user wishing to configure a website enters this phrase into the target search phrase field 1602. The user then clicks the update phrase button 1603 in order to populate the search engine tagging fields 1604, 1605, 1607, 1609, 1611, 1613, 1614. The search engine tagging fields 1604, 1605, 1607, 1609, 1611, 1613, 1614 are then used to configure the specified website's programming code as described below. In one embodiment, the system automatically suggests a target phrase and tags based on previously entered user information.

After a user enters the desired target search phrase and clicks the update phrase button 1603, the automatic website design interface 109 automatically selects information based on the target search phrase to enter into the search engine tagging fields 1604, 1605, 1607, 1609, 1611, 1613, 1614. For example, if the target search phrase is “Real Estate in Newport Beach California,” the automatic website design interface 109 inserts “Real Estate, housing, homes, house, property, land, realty in Newport Beach, Newport Coast, California” into the file name field 1605. If a file name already exists, the automatic website design interface 109 may add the target search phrase to the end or beginning of the existing file name or it may alter or delete the existing file name in favor of the target search engine phrase. Likewise, the automatic website design interface 109 adds to, replaces, creates or alters an exiting descriptive title, H1 tags, Alt tags, Meta keywords, Meta descriptions and link names based on the target search phrase entered. Various criteria may be used to determine appropriate tags including length, word repetition, word synonyms, surrounding locations, keywords, etc.

Once the automatic website design interface 109 adds to, replaces, creates, or alters the information in the search engine tagging fields 1604, 1605, 1607, 1609, 1611, 1613, 1614 the automatic website design interface 109 populates the search engine tagging fields 1604, 1605, 1607, 1609, 1611, 1613, 1614 with the new search engine tagging information. A user then has the opportunity to review the search engine tagging fields and make changes where desired.

Alternatively, a user can manually enter information into the search engine tagging fields 1604, 1605, 1607, 1609, 1611, 1613, 1614. Field 1604 allows a user to enter a descriptive title. Field 1605 allows a user to enter a file name under which to save the website. Field 1607 allows a user to create an H1 tag on the website. Field 1609 allows a user to create an alt tag for the website. Field 1611 allows a user to enter meta keywords for inclusion in the website. Field 1613 allows a user to enter meta description information for inclusion in the website. Field 1614 allows a user to enter link names for inclusion in the website. Although described in relation to certain fields, it will be understood by a person of ordinary skill in the art that various other tagging fields can be used. The tagging fields described herein are made by way of example and not limitation. It will also be understood by persons of skill in the art that multiple tagging fields can be used for the same tag type. For example, if a website contains more than one Alt tag, a separate Alt tag field can be used for each alt tag used on the website.

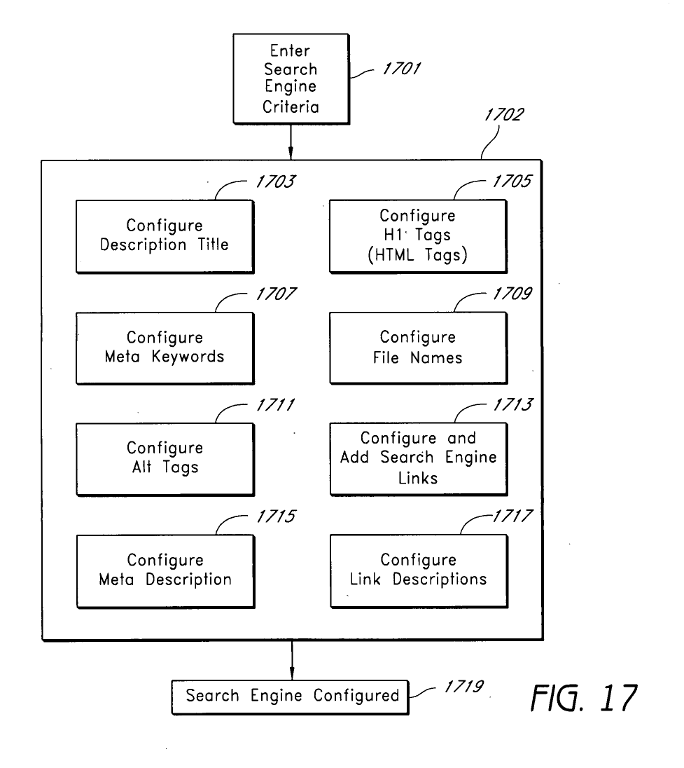

Once a user is satisfied with the search engine tagging field inputs, the user then clicks the save changes button 1615 in order to configure the website based on the tagging fields. FIG. 17 illustrates the configuration process. Search engine tagging fields are entered at block 1701, as described above. The system then moves on to block 1702 which contains configuration modules used to configure the website. Each module configures a different aspect of the website. The modules can operate in parallel, or one at a time. The modules can also operate in any order.

The configure descriptive title module 1703 updates the website's descriptive title based on the information entered in the descriptive title tagging field 1604: The configure H1 tags module 1705 updates the website's H1 tags based on the information entered in the H1 tagging field 1607. The configure meta keyword module 1707 updates the meta keywords based on the information entered in the meta keyword tagging field 1611. The configure file name module 1709 updates the website's file name based on the information entered in the file name field 1605. The configure alt tags module 1711 updates the website's alt tags based on the information entered in the alt tagging field 1609. The configure and add search engine links module 1713 updates and creates links to highly ranked web pages based on the target search phrase and other search engine tagging fields. The configure meta description module 1715 updates and creates the website's meta description based on the information entered in the meta description tagging field 1613. The configure link descriptions module 1717 updates the website's link descriptions based on the information entered in the link descriptions tagging field 1614.

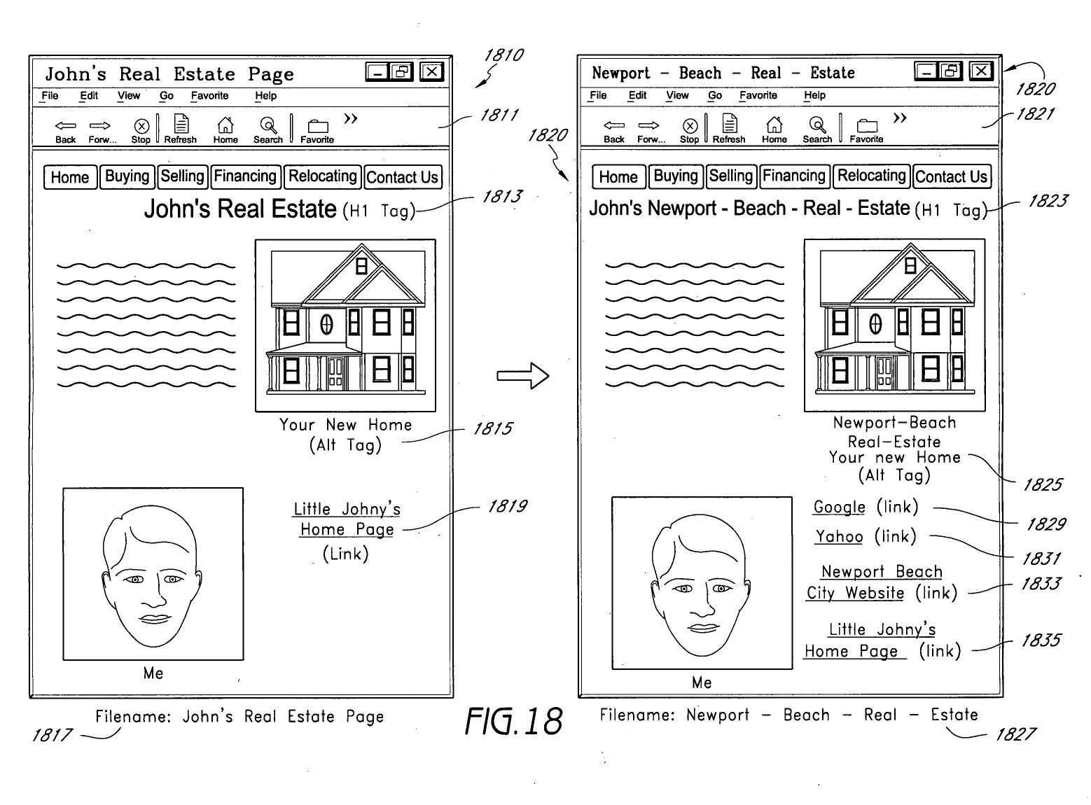

FIG. 18 illustrates a website before and after configuration. Before automatic configuration, website 1810 has a descriptive title 1811, an H1 tag 1813, an alt tag 1815, a file name 1817, and a link. In the embodiment of FIG. 18, a search engine would not likely associate website 1810 with a search for “Newport Beach Real Estate” because there are few, if any, indications of website's 1810 relation to real estate in Newport Beach.

Website 1820 illustrates website 1810 after configuration. As illustrated in FIG. 18, the descriptive title 1821 has been configured to indicate that the website is targeted toward Newport Beach real estate. Likewise, the H1 tag 1823 has been updated to include the words Newport Beach real estate as well. The alt tag 1825 has also been updated with Newport Beach real estate. The file name 1827 also includes the words Newport Beach real estate. In addition, highly ranked links 1829, 1831, 1833 have been added to the webpage. Highly ranked links, such as, for example, links 1829, 1831, 1833 can be found in various ways. For example, in one embodiment, highly ranked links are found by automatically searching a search engine for the target phrase and linking to the highest ranked websites. In an alternative embodiment, a list of generic highly ranked websites, such as, for example, Google® and Yahoo®, can be automatically inserted into every configured website. Other methods of finding highly ranked websites to link to can also be used. It will be understood by a person of skill in the art that a website with multiple tag fields, such as multiple alt tags or H1 tags, can also configured using the present disclosure.

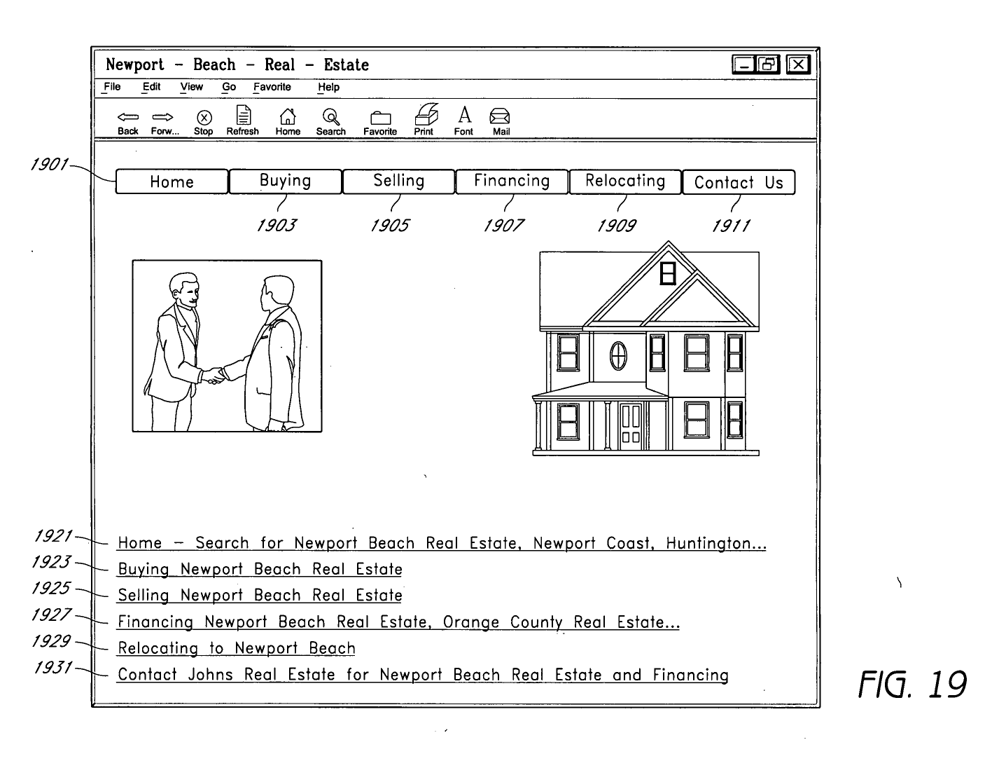

FIG. 19 illustrates an example of link aliasing. In link aliasing, a minimally descriptive link is placed near the top of the webpage, while a more descriptive corresponding link is placed near the bottom of the webpage. For example, in the embodiment illustrated in FIG. 19, a link 1901 is labeled as “HOME” while at the bottom of the page, a more descriptive corresponding link 1921 is labeled as “Home—Search for Newport Beach Real Estate, Newport Coast, Huntington . . . ” This system of link aliasing allows the website to have longer link descriptions while still being aesthetically pleasing and easily navigated by viewers. Link aliasing can be used with one or multiple links. For example, in the embodiment of FIG. 19, aliased links 1901, 1903, 1905, 1907, 1909, 1911 all have corresponding links 1921, 1923, 1925, 1927, 1929, 1931 near the bottom of the web page.

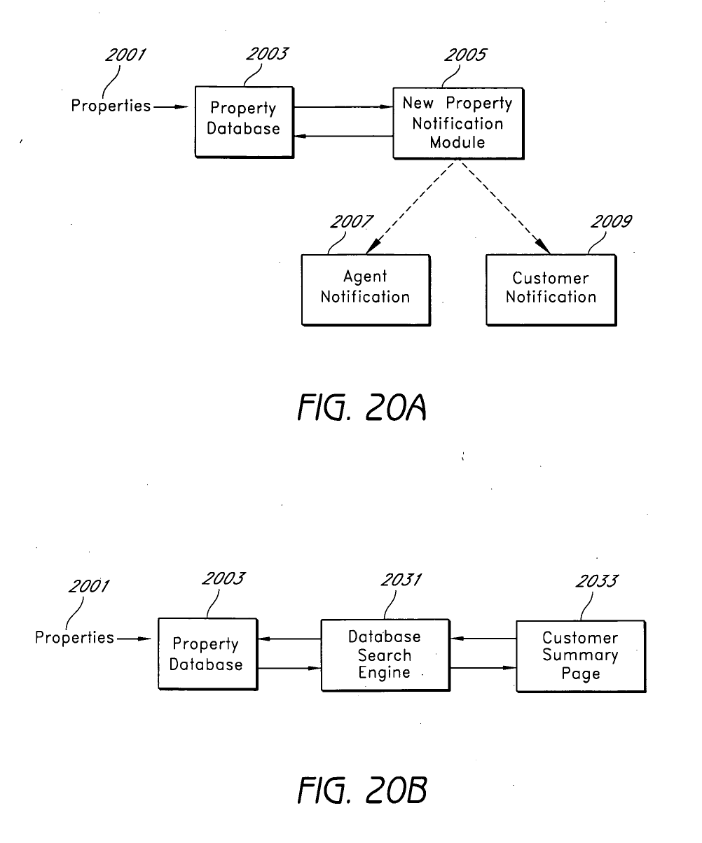

FIGS. 20A and 20B illustrate one embodiment of a client new property notification system. The client new property notification system provides a quick client notification system when a new property is listed on a property database 2003, such as, for example, an MLS. Quick notification of new listings is often important so that a potential buyer can quickly make a decision as to whether to offer to purchase a particular property. In order to allow quick communication, the new property notification module 2005 is provided. The new property notification module 2005 performs routine searches on the property database 2003 and/or receives periodic updates from the property database 2003. When a new property is listed, the new property notification module 2005 automatically text messages, e-mails, faxes, telephones, or otherwise contacts both the agent and the customer. The agent is contacted via the agent notification module 2007 and the customer is notified via the customer notification module 2009 so that they may receive quick notification when a new property is listed. In a preferred embodiment, the notification is sent via a text message or instant message to a customer and/or agent's cell phone.

FIG. 20B illustrates one embodiment of system for updating a summary page in which a customer is able to keep track of their viewed properties. When properties 2001 are listed on a property database 2003, a property search engine 2031 searches on a regular basis the property database 2003 and produces results based on search criteria entered by the user. When a new property is found in the property database, the property is sent to and incorporated within a customer summary page 2033. The customer summary page 2033 lists the properties found by the search engine, and allows a user to categorize the properties. The customer summary page also provides an area where a customer can input search criteria to be sent to the MLS search engine for searching the MLS 2003.

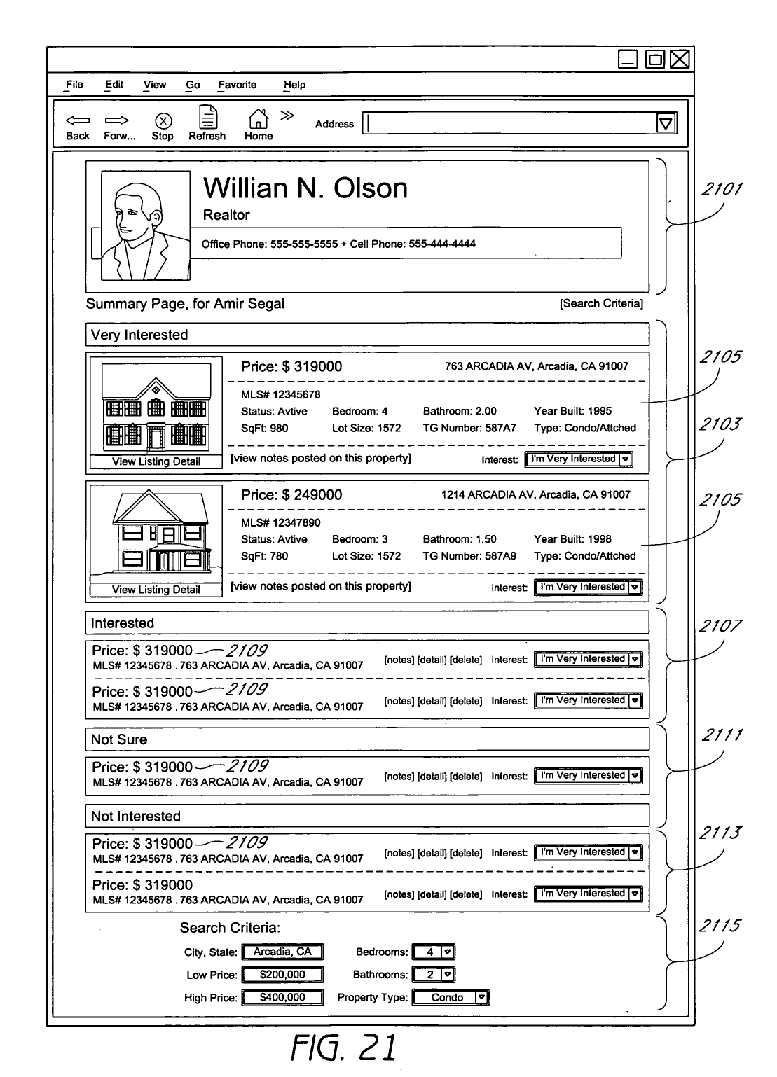

FIG. 21 illustrates one embodiment of a customer summary page. In one embodiment, the customer summary page is created through the real estate agent's website so that the customer summary page as the look and feel of the real estate agent's website. In addition to having the look and feel of the agent's website, it also contains header information 2101 with the agent's contact information. The agent can view the customer summary page to see which properties a customer has viewed and which properties a customer prefers in order to get a better idea of what the customer is looking for.

The summary page has several categories into which a customer can place viewed properties. The summary page has a very interested property section 2103, an interested property section 2107, a not sure property section 2111, and a not interested property section 2113. In addition, section 2115 provides an area where a user can input search criteria in order to find properties listed in the property database 2003. Note that the very interested section 2103 has properties 2105. Properties 2105 have more detail than the other properties listed in the other sections, such as the interested section 2107, the not sure section 2111, and the not interested section 2103. The properties in these sections, such as properties 2109, are listed with less information so that less area on the page is taken up. Of course, it is to be understood by a person of ordinary skill in the art that the properties can be listed on the customer summary page with more or less information, including pictures and links to pages with more information.

Although the foregoing invention has been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. It is contemplated that various aspects and features of the invention described can be practiced separately, combined together, or substituted for one another, and that a variety of combination and subcombinations of the features and aspects can be made and still fall within the scope of the invention. Furthermore, the systems described above need not include all of the modules and functions described in the preferred embodiments. Accordingly, the present invention is not intended to be limited by the recitation of the preferred embodiments, but is to be defined by reference to the appended claims.

What is claimed is:

1. A method for link aliasing, the method comprising
providing a desired link from a first website to a second website;
generating a short description for the link and a long description for the link; and
automatically incorporating at least two links to the first website, wherein one of the at least two links comprises the short description and one of the at least two links comprises the long description.

2. The method of claim 1, further comprising automatically incorporating at least one of the two links into a navigation section.

3. The method of claim 1, further comprising automatically locating the short descriptive link on a top portion of the website.

4. The method of claim 1, further comprising automatically locating the short descriptive link on a side portion of the website.

5. The method of claim 1, further comprising automatically locating the long descriptive link on a bottom portion of the website.

6. The method of claim 1, wherein at least one of the links is a flash based link.

7. The automated method of claim 1, wherein at least one of the links is an HTML based link.

8. An organizational structure for a website, the organizational structure comprising:
a homepage comprising a first navigation section;
a subsection of webpages comprising a plurality of webpages;
wherein each webpage in the subsection of webpages comprises the first navigation section and a second navigation section;
wherein the first navigation section comprises a link to at least one of the pages of the subsection of webpages;
wherein the second navigation section comprises a plurality of links corresponding to the plurality of pages of the subsection of webpages; and
wherein the website is generated by a software function using a user modified template.

9. A method of organizing webpages for automatically generating a website, the method comprising:
providing a user customizable homepage;
providing a first plurality of user customizable webpages;
providing a website organization user interface;
organizing the first plurality of user customizable webpages based on a user's input into sections comprising a second plurality of webpages selected from the first plurality of webpages;
linking each webpage in the second plurality of webpages to every other webpage in the second plurality of webpages; and
linking at least one page in the second plurality of webpages from the homepage;
wherein organizing and linking comprises using a software module run on a processor.

10. A template based webpage comprising:
a first navigation section comprising at least one link;
a dynamic content section comprising at least one content block selectable by a user; and
a footer section comprising at least one link;
wherein first navigation section, the dynamic content section and the footer section are user customizable based on user inputs and implemented using a software module run on a processor.

11. The template based webpage of claim 10, further comprising at least a second content block selectable by the user.

12. the template based webpage of claim 11, wherein the content blocks are configured to be spatially arranged by the user.

13. The template based webpage of claim 10, wherein the at least one content block comprises a user customizable pre-designed webpage content section.

14. The template based webpage of claim 10, further comprising a second navigation section comprising at least one link.

15. A system for customizing a template based webpage, the system comprising:
a template based webpage comprising at least one user customizable content area;
a content block user interface comprising at least one content block wherein the content block user interface is configured to allow a user to customize a content block; and
wherein the content block user interface is further configured to automatically incorporate the user customizable content block into the user customizable content area.

16. The system of claim 15, wherein the at least one content block comprises at least two content blocks.

17. A method for customizing a template based webpage comprising:
providing a template based webpage comprising at least one user customizable content area;
providing a content block user interface comprising at least one content block wherein the content block user interface is configured to allow a user to customize a content block; and
automatically incorporating the user configured content block into the user customizable content area.
